(19) United States
(12) Patent Application Publication
(10) Pub. No.: US 2012/0181371 A1
(43) Pub. Date: Jul. 19, 2012

(54) Roll Dispenser

(75) Inventors: Paul Omdoll, Brookfield, WI (US); Scott J. Collins, Milwaukee, WI (US)

(73) Assignee: U.S. BANK NATIONAL ASSOCIATION, St. Louis, MO (US)

(21) Appl. No.: 13/142,112

(22) PCT Filed: Oct. 6, 2010
(86) PCT No.: PCT/US2010/051613

§ 371 Date: Jun. 24, 2011

Related U.S. Application Data
(60) Provisional application No. 61/249,131, filed on Oct. 6, 2009.

(51) Int. Cl. A47K 10/38; G05G 1/04

(52) U.S. Cl. 242/564.2; 74/523

(57) ABSTRACT

A web dispenser is fitted with a crank that extends from the side or below the dispenser and is ergonomically shaped to receive the edge of a user's hand rather than the palm side of the user's hand. The crank interfaces with an advance mechanism in the dispenser that advances web material from the roll as the crank is pushed downward. The crank has a curved body that forms a recess or depression for receiving the edge of the user's hand.

### CROSS-REFERENCE TO RELATED APPLICATION

This application claims the benefit of U.S. Ser. No. 61/249,131 filed Oct. 6, 2009, the disclosure of which is incorporated herein by reference.

### BACKGROUND OF THE INVENTION

This invention relates generally to dispensers for dispensing sheet material. More particularly, this invention relates to a low cost roll dispenser for dispensing paper towels and having a side mounted ergonomic advancement lever.

Dispensers for rolls of flexible sheet material, such as paper toweling, have been employed for a great many years. Dispensers are widely used in public lavatories to dispense paper toweling for users to dry their hands. Typically, a roll of sheet material is rotatably supported inside the dispenser cabinet. A user actuates a lever that drives a feed mechanism for dispensing the sheet material. The feed mechanism typically includes a drive roller and an idle roller. The lever interacts with the drive roller so that actuation of the lever rotates the drive roller. Rotation of the drive roller acts to unwind the sheet material roll. The lever is usually a separate mechanism from the housing of the roll dispenser, such as that shown in U.S. Pat. No. 7,168,653, the disclosure of which is incorporated herein.

The dispenser described in the above-referenced patent as well as other manually activated dispensers have a lever mounted to or extending from the front of the dispenser. The lever interfaces with the drive roller such that when the lever is forced downward, e.g., pushed or pulled, the drive roller advances the sheet material roll. The orientation of the lever invites a user to place his palm or the palmar side of his fingers against the lever and force down. In some cases, the lever invites a user to grasp the lever and pull down. In either case, the palm side of the hand contacts the lever.

Increasingly, users are reluctant to have their palms contact such dispensers in an effort to avoid contact with possible contagions. As a result many users find hand levers unacceptable and frustratingly, do not dry their hands before exiting a lavatory. Other users will try to engage the lever with their arm, e.g., elbow, or the dorsal side of their hand. While some users have been able to make such an effort work, for many users and dispensers it is difficult, if not impossible, to apply sufficient pushing force to advance the sheet material roll. One solution has been the implementation of so-called “contactless” dispensers that use proximity sensors to detect the presence of a hand about the dispenser and a motorized feed assembly to advance the sheet material roll. Contactless dispensers, however, can be costly and therefore may not be a viable solution in some cases.

Accordingly, a need exists for a low cost roll dispenser that allows a user to manually advance a sheet material roll in a more user acceptable manner.

### SUMMARY OF THE INVENTION

The present invention provides a dispenser for dispensing web material from a roll contained within the dispenser. The dispenser is fitted with a crank or lever that extends from a side or below the dispenser. The crank is ergonomically shaped to receive the edge of a user's hand rather than the face or palmar side of the user's hand. The crank has a curved body that is angled toward the front of the dispenser and forms a depression for receiving the edge of the user's hand. The crank interfaces with an advance mechanism of the dispenser such that when the crank is pushed downward, the advance mechanism advances web material from the roll. In one embodiment, the dispenser includes a ramp structure for biasing the roll of web material toward the advance mechanism as the roll is depleted.

It is therefore an object of the invention to provide a dispenser that is ergonomically friendly.

It is another object of the invention to provide a dispenser that can be caused to advance web material by a crank or lever that can be engaged by a germ-conscious user in a manner that is appealing to such a user.

It is another object of the invention to provide a crank for a dispenser that is shaped to receive the edge of a user's hand rather than the palmar side of the user's hand.

Various other features, objects and advantages of the invention will be made apparent from the following description taken together with the drawings.

### DESCRIPTION OF THE DRAWINGS

FIG. 1 is a perspective view of a low cost roll dispenser in accordance with one embodiment of the present invention;

FIG. 2 is a front elevation view of the dispenser of FIG. 1;

FIG. 3 is a left side elevation view of the dispenser of FIG. 1;

FIG. 4 is a rear elevation view of the dispenser of FIG. 1;

FIG. 5 is a top plan of the dispenser of FIG. 1;

FIG. 6 is a right side elevation view of the dispenser of FIG. 1;

FIG. 7 is a bottom plan view of the dispenser of FIG. 1;

FIG. 8 is an isometric view of the dispenser of FIG. 1 with a front cover of the dispenser removed;

FIG. 9 is an isometric view of an interior side of the housing of the dispenser of FIG. 1;

FIG. 10 is an isometric view of a lever for the dispenser of FIG. 1 according to one embodiment of the invention;

FIG. 11 is a front elevation view of the lever of FIG. 10;

FIG. 12 is a left side elevation view of the lever of FIG. 10;

FIG. 13 is a rear elevation view of the lever of FIG. 10;

FIG. 14 is a top elevation view of the lever of FIG. 10; and

FIG. 15 is a pictorial view of a hand illustrating a preferred engagement area with the lever of FIG. 10.

### DETAILED DESCRIPTION OF THE PREFERRED EMBODIMENTS

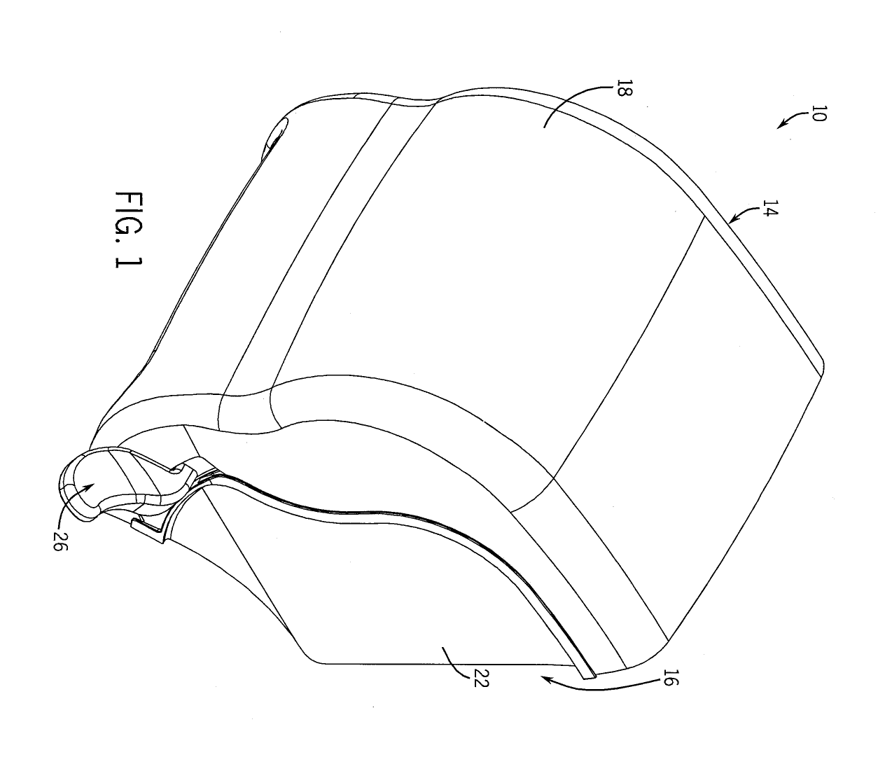

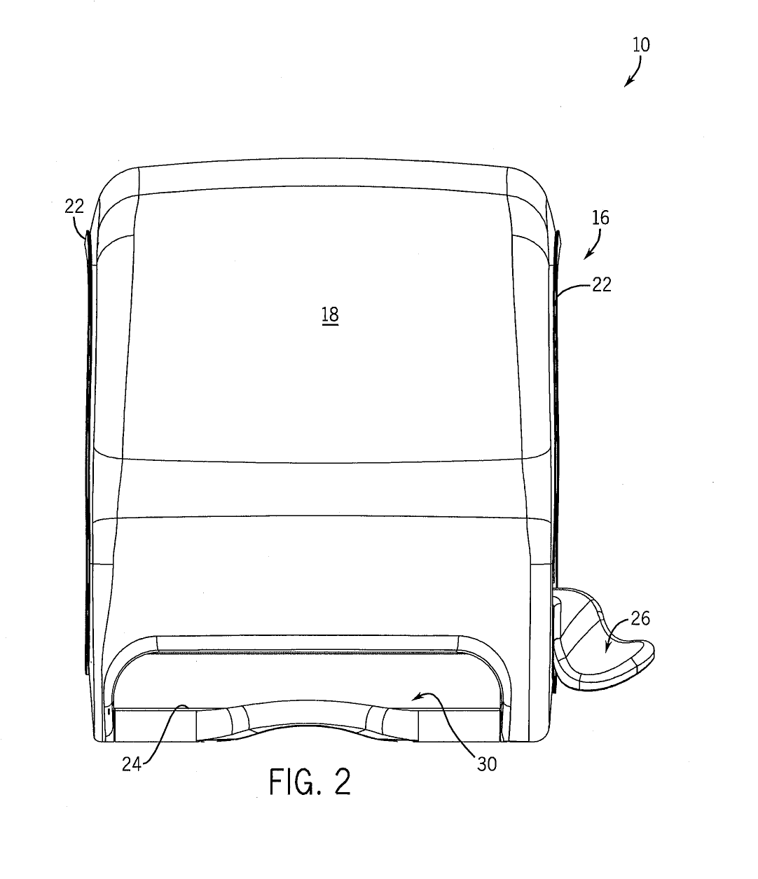

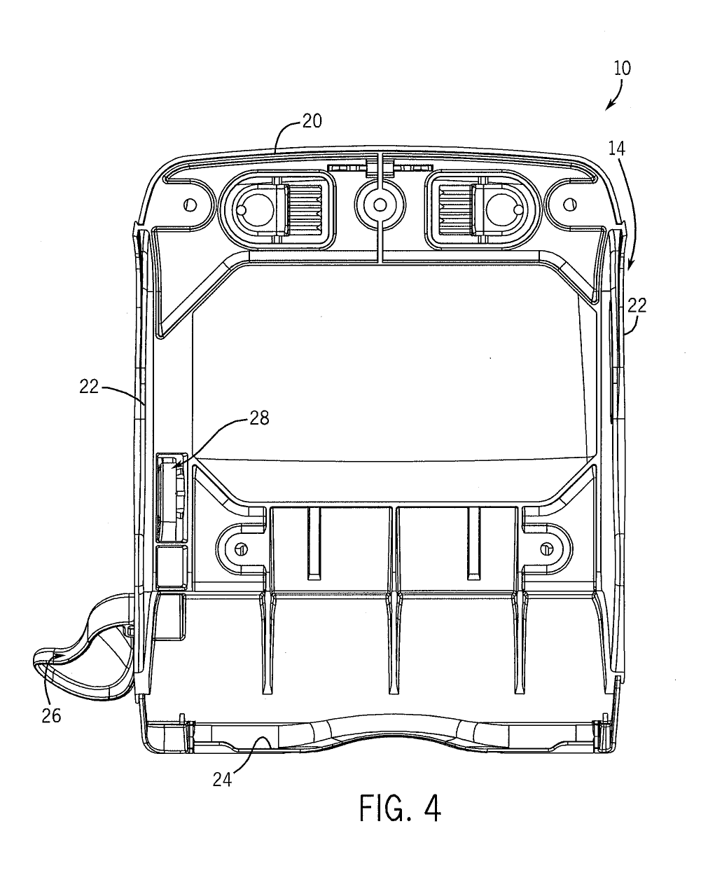

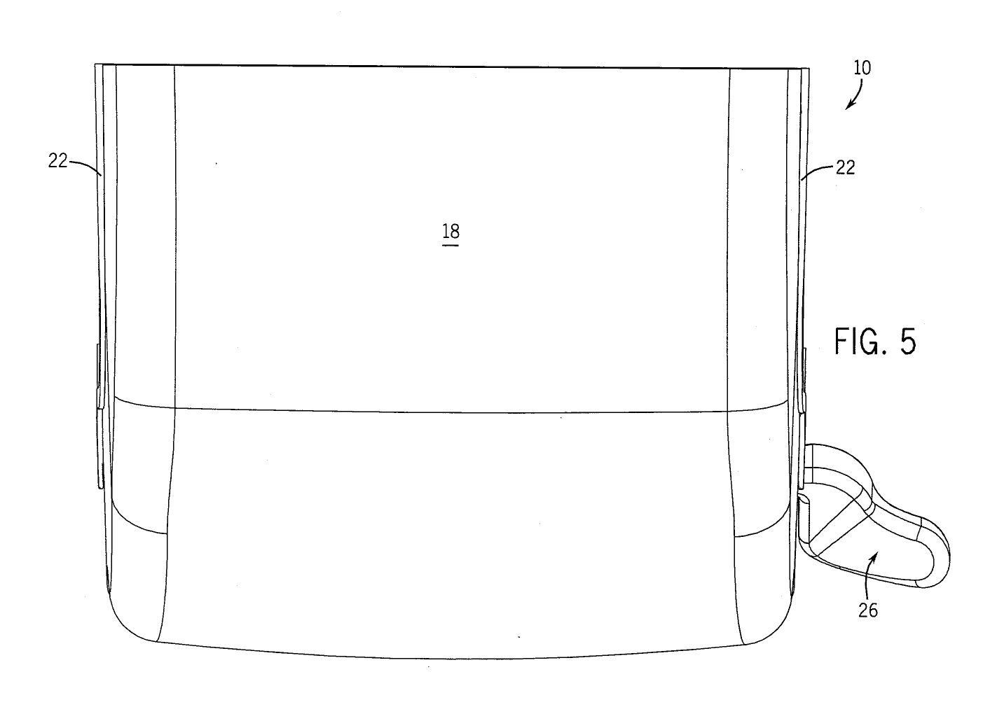

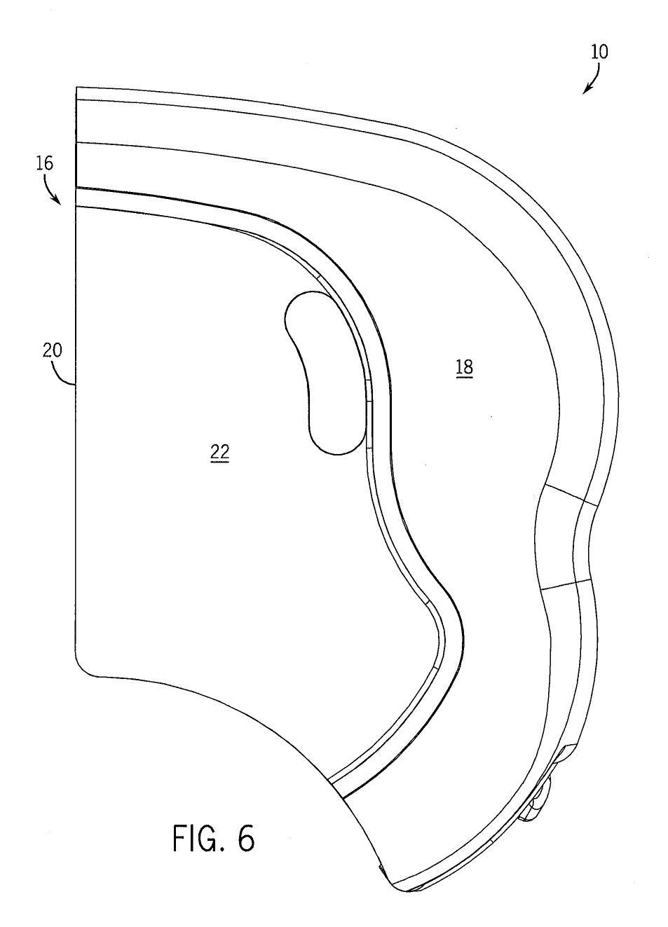

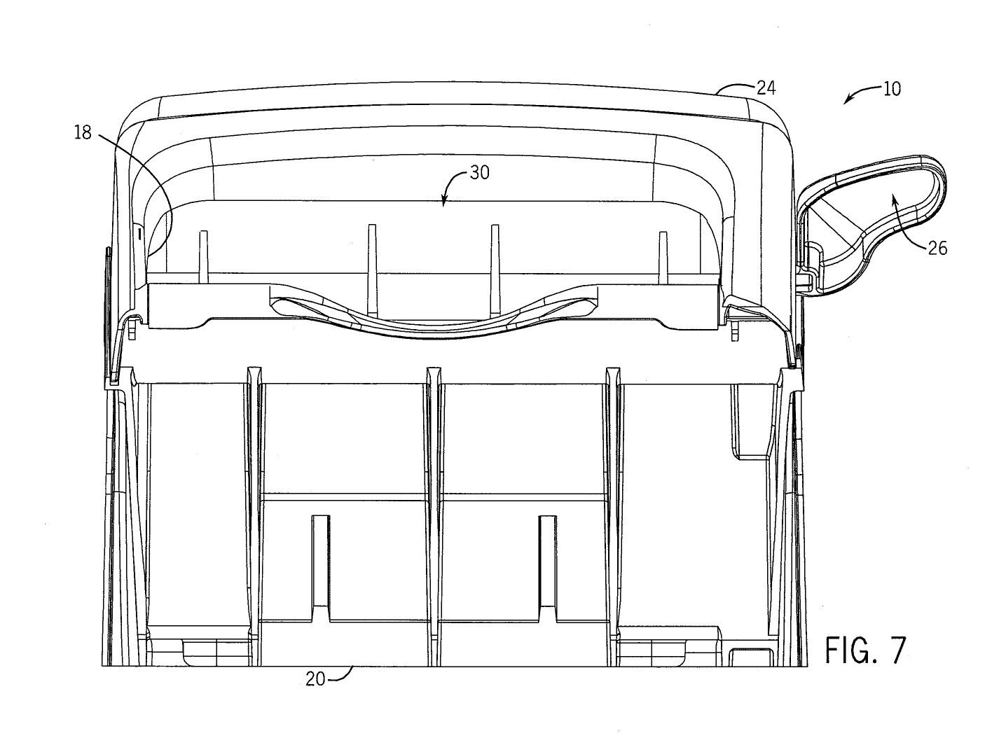

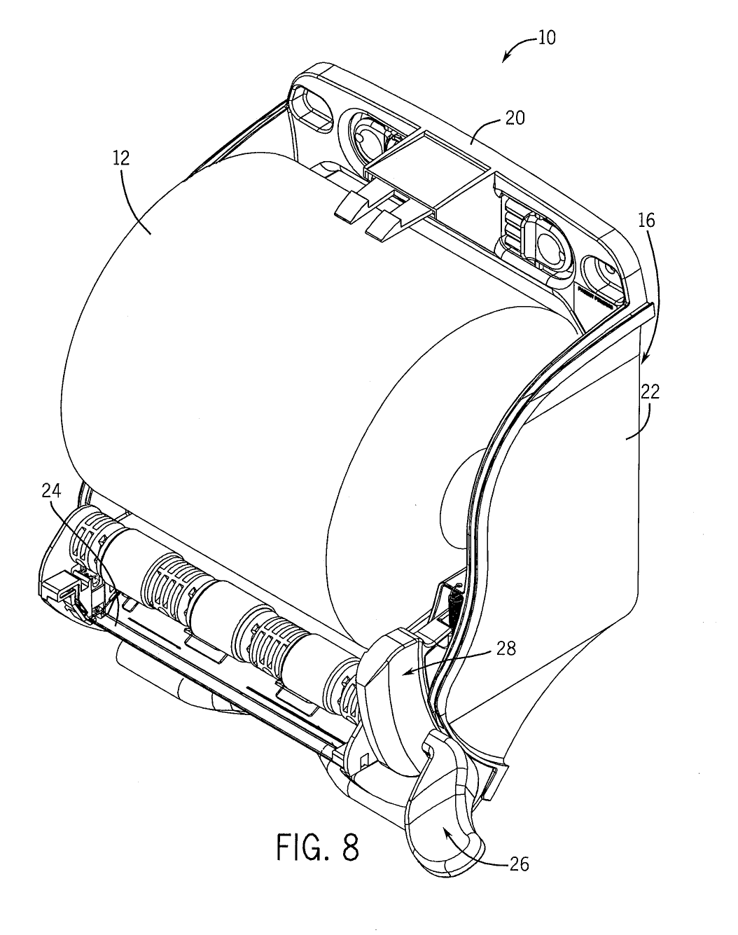

A low cost roll dispenser (identified generally as 10) in accordance with the present invention is shown in FIGS. 1 through 9. While the invention may be susceptible to embodiment in different forms, there is shown in the drawings, and herein is described in detail, an illustrative embodiment with the understanding that the present disclosure is to be considered an exemplification of the principles of the invention, and is not intended to limit the invention to those as illustrated and described herein. Additionally, features illustrated and described with respect to one embodiment could be used in connection with other embodiments.

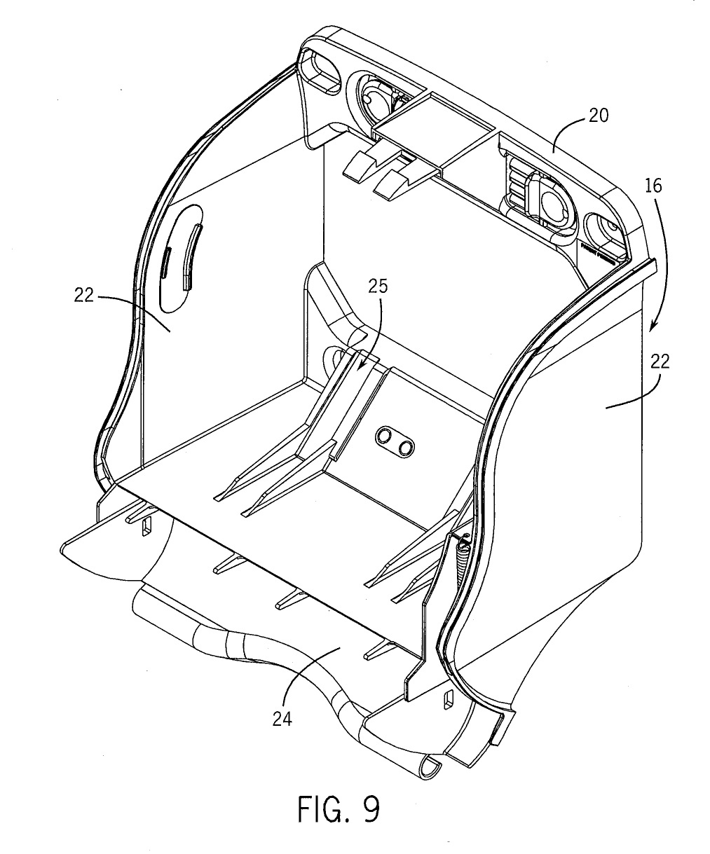

The low cost roll dispenser 10 of the present invention holds a roll of dispensable material 12 inside an enclosure 14 collectively defined by a rear housing 16 and a front cover 18 coupled to the rear housing 16 in a manner that allows the front cover 18 to be rotated away from the rear housing 16 to permit access to the interior of the enclosure 14, such as installation of a roll. The rear housing 16 comprises a back wall 20, sidewalls 22, and a floor 24. The housing 16 and the cover 18 may be formed of plastic or other suitable material. The back wall 20, sidewalls 22, and floor 24 may be a single piece formed by injection, blow, or roto molding. Alternatively, they may be separately manufactured parts that are connected by welds, moldings, fasteners, solder, or the like. The cover 18 is preferably a single piece formed by injection, blow, or roto molding. As best show in FIG. 9, the interior surface of the back wall 20 includes a ramp structure 25 with a shape that biases the roll forward onto a feeding mechanism (not shown) so that the roll is in constant contact with both the rear wall 20 and the feed mechanism. The roll substantially maintains these contacts while the roll is stationary and while the roll is being unwound.

Once the roll 12 is placed inside the dispenser 10 of the present invention, the outer surface of the roll 12 is biased by gravity against the ramp and the outer surface of a drive roller (not shown). The result is that the roll 12 exerts a pressure on the drive roller that varies in relation to the mass of the roll 12. By virtue of the shape of the ramp structure 25, the roll 12 is indexed or biased forward so that it applies a substantially constant pressure to the drive roller yet minimizes the drag and force required to rotate the roll 12. Preferably, the applied pressure is not great enough to create excessive drag between the roll 12 and the driver roller and to allow a low actuation force to dispense sheet material even when the roll 12 is large. Specifically, in one embodiment for use with 800 foot paper towel rolls, less than 5 pounds of pressure is required to dispense sheet material.

The shape of the ramp structure 25 also is configured to provide sufficient pressure to prevent the roll 12 from bouncing uncontrollably around the inside of the housing when being dispensed. More particularly, the gravity-biased engagement of the roll 12 with the drive roller and the shape prevents the roll 12 from freewheeling when handle 26 is actuated. Preferably, the sheet material is unwound from the bottom of the roll 12. In addition, the roll 12 is in rolling engagement with the drive roller. This combination allows the rotation of the drive roller to rotate and thereby unwind the roll 12. The result is that it is possible to pull the sheet material and unwind the roll without the need for the use of appreciable force.

This design eliminates the need for the many parts normally required to support the roll in traditional roll dispensers. As a result, the costs of manufacturing, maintaining, and repairing the dispenser 10 of the present invention are reduced. In addition, this design allows for ease in refilling the dispenser 10 with rolls 12. There is no need to attach any parts to the roll 12 nor fit the roll 12 onto any supports or guides. Instead, the cover 18 is opened, the core removed, (if there is one) a new roll 12 placed on the ramp structure 25, the lead of the roll fed through the feeding mechanism, and the cover 18 is closed. As a result, the low cost roll dispenser 10 can accommodate and dispense sheet material from both core and core-less rolls without any modification or installation of additional parts.

In a preferred embodiment of the present invention the ramp structure 25 is formed by a series of support ridges provided along the interior surface of the back wall 20. In still another embodiment, the ramp is a single, solid support mounted to the interior surface of the back wall 20.

The dispenser 10 of the present invention provides for a lever 26 that extends through an opening (not numbered) in a sidewall 22 of the rear housing 16. The lever 26 attaches to a drive lever 28 held within the interior of the dispenser 10. The drive lever 28 engages the feed mechanism (not shown) of the dispenser 10 in a known manner. More particularly, actuation of the lever 26 rotates a drive roller (not shown) thereby unwinding the roll 12. Unwinding the roll 12 produces a predetermined amount of sheet material that is presented through a mouth 30 formed between the front cover 18 and the floor 24 of the dispenser 10.

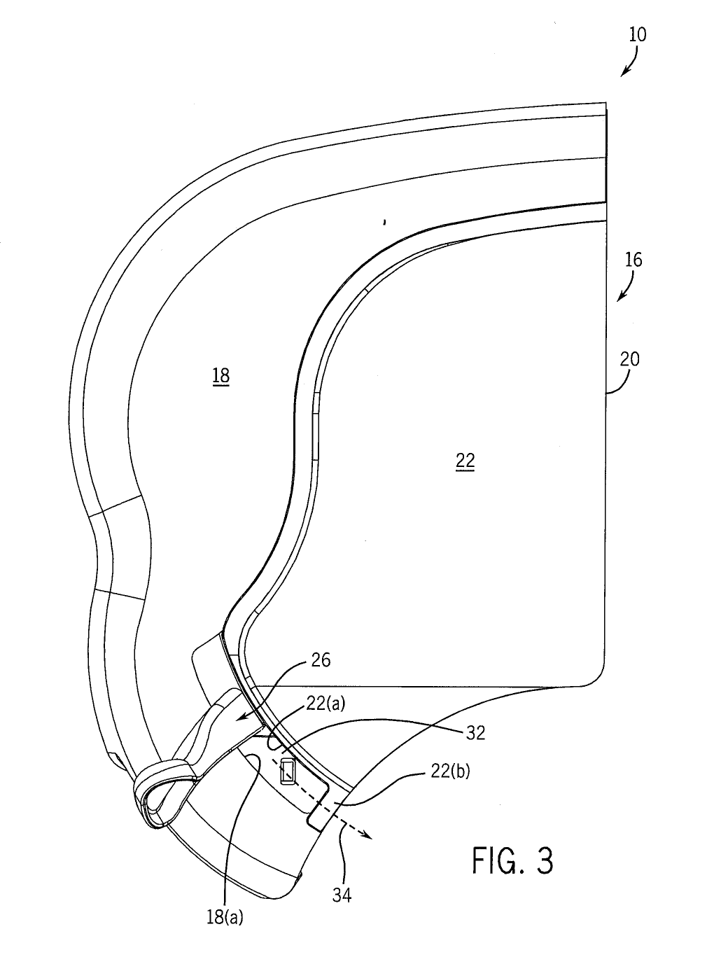

As best shown in FIG. 3, the lever 26 slides along a curved channel 32 formed between a front edge 22(a) of the sidewall 22 and a rear edge 18(a) of the front cover 18. As shown in FIG. 3, the channel 32 generally extends along an axis 34 that is at an angle relative to the plane of the back wall 20. In one preferred embodiment, the angle is approximately 45 degrees. In this regard, a downward and forward (toward the back wall 20 of the rear housing 16) force will cause the lever 26 to move from the position shown in FIG. 3 to a position approximate the lower edge 22(b) of the sidewall 22. It is believed that this downward and forward movement is more natural for most users and therefore seemingly less effort is required to actuate the lever 26. Such a movement of the lever 26 will also cause the drive lever 28 to rotate. As the drive lever 28 interfaces the drive roller (not shown), the drive roller will follow rotation of the drive 28 and advance sheet material from the sheet material roll 12.

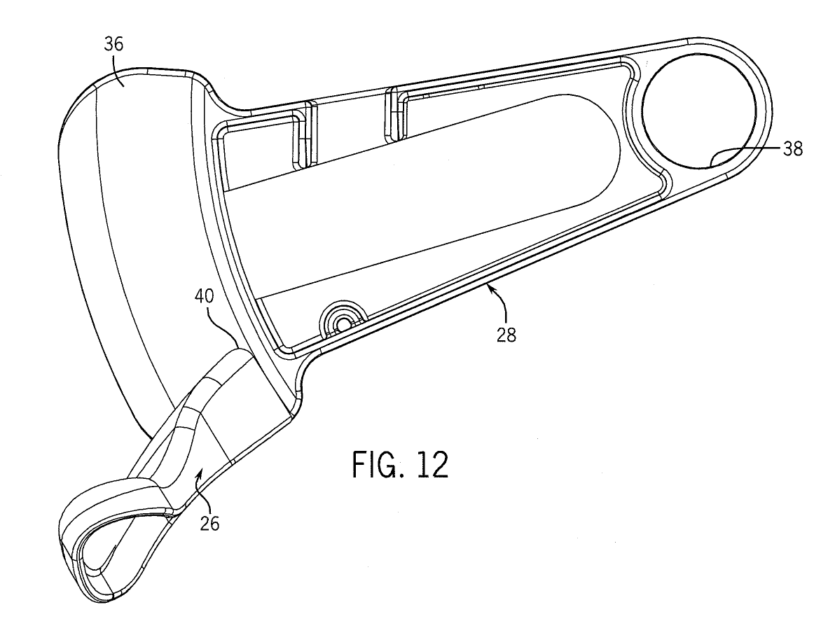

As shown in FIG. 12, the driver lever 28 has a generally wedged shaped body 36 that includes a pivot mount 38 that interfaces with an end of the drive roller (not shown). The lever 26 is coupled to an end of the body 36 opposite the pivot mount 38. In one preferred embodiment, the lever 26 snap fits into a receiver 40 formed in the exterior side of the lever body 36. Alternately, the lever 26 and the body 36 can be formed as a single, unitary structure.

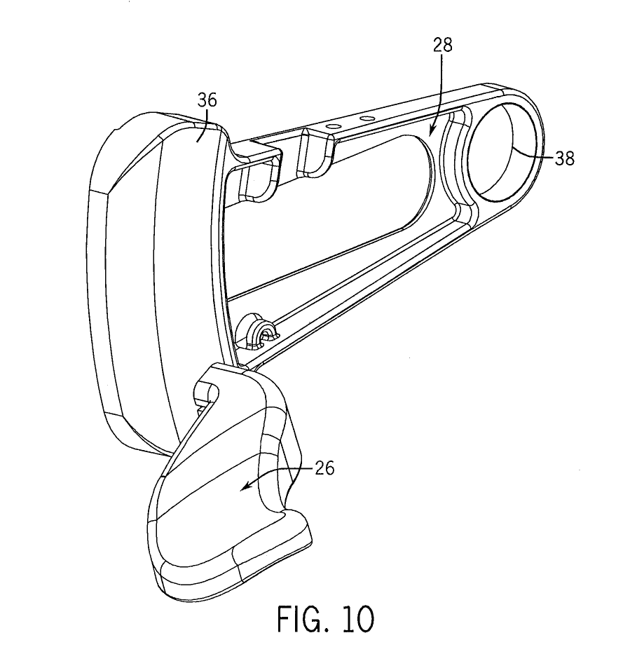

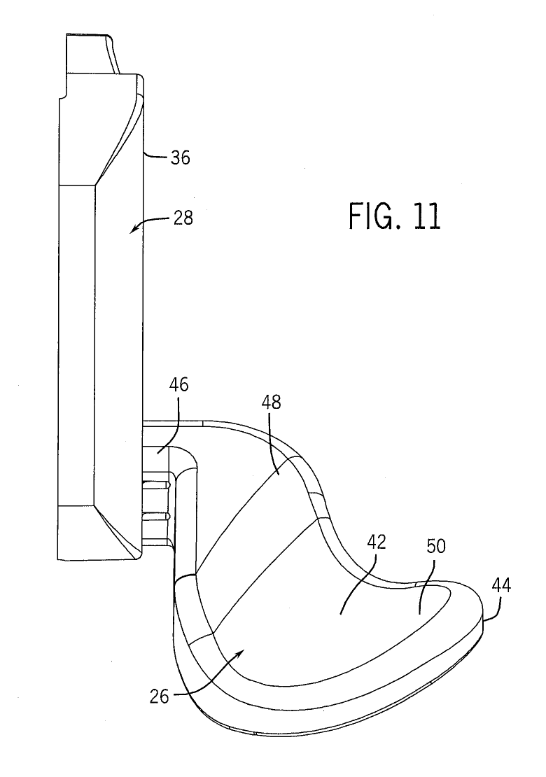

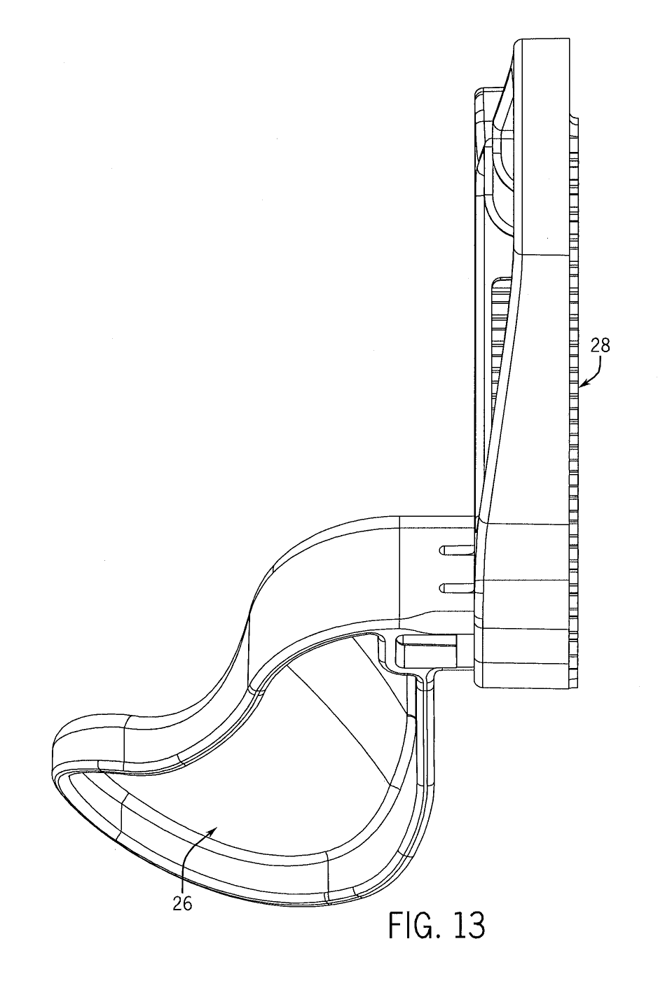

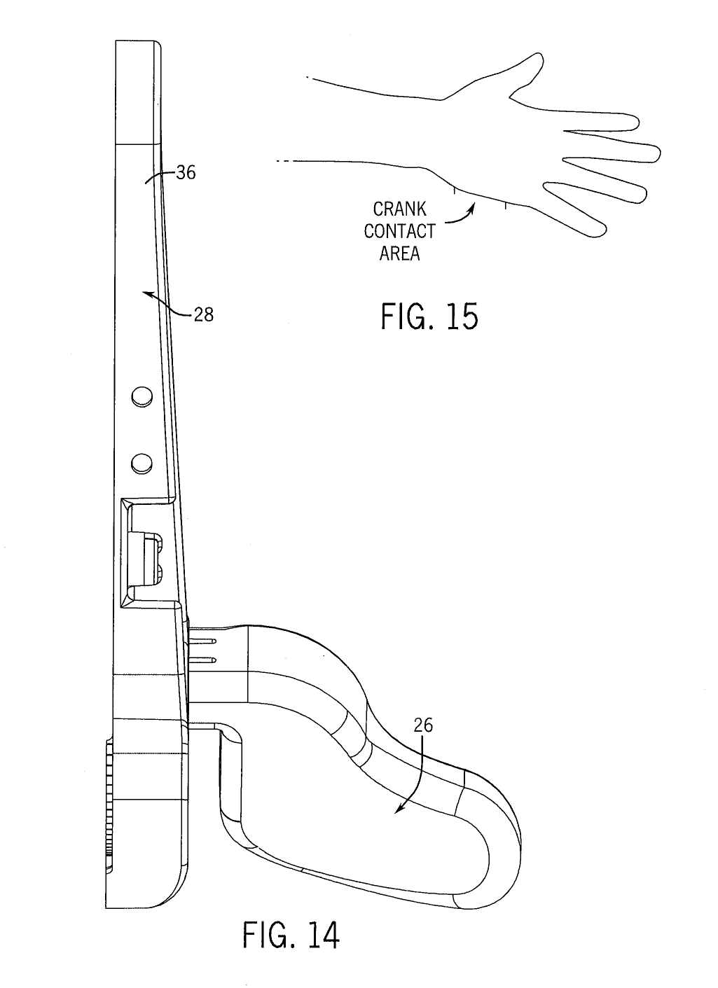

It will be appreciated that the lever 26 is designed so as to improve the functionality of the dispenser 10 as well as user acceptability of the dispenser 10. The position and the shape of the lever 26 is such that a user can apply sufficient force to push the lever 26 along the curved channel 32 and rotate the drive lever 28 without the need to engage the user's palm with the lever 26. This appeals to users who desire to avoid such contact in public settings where the sanitation level is unknown. More particularly, and with particular reference to FIGS. 10-14, the lever 26 has a curved body 42 that is slightly recessed between an outer lever end 44 and an inner lever end 46. The curved body 42 has a downwardly extending curvature 48 and an upwardly extending curvature 50. As a result, the body 42 has a generally convex shape that provides a depression into which the edge (intersection of palm and dorsal sides) of a user's hand can be loaded to engage the lever 26 (see FIG. 15).

While the palm of a user's hand may be used to engage the lever 26, the lever 26 is shaped to accommodate users who typically use the edge (intersection of the palm and dorsal side) of their hand or wrist to engage dispenser levers as shown in FIG. 15. The lever 26 is angled from the sidewall 22 so that a user can effectively engage the edge of his hand in one of two general positions. The first position is similar to the so-called “handshake” position in which the palm of the hand is rotated uprightly approximately 90 degrees and the fingers are extended and aligned with the wrist. The second position is similar to the handshake position, i.e., palm rotated upright approximately 90 degrees, but the fingers are cupped inward and the wrist is cocked slightly inward (toward the sidewall 22 of the dispenser 10). This latter position is commonly used by users for non-palm engagement of conventional front mounted dispenser levers, and thus the present invention provides a lever usable with a user's customary practice. Moreover, it will be appreciated that the lever 26 is designed such that it provides equal ergonomics whether engaged by a user's left hand or right hand. Further, it will be appreciated that the lever 26 is shaped so as to shed water so that when a user with wet hands makes contact with the lever 26, the lever 26 will shed any residual water that strikes the lever 26.

In one embodiment of the present invention, the dispenser 10 is partially or completely formed of a transparent material. Employing a transparent material allows a service person to see the amount of sheet material remaining in the dispenser 10 without opening the cover 18.

Additionally, while dispenser 10 has been described as having a side extending lever, it is understood that the lever could be placed so as to extend from the front of the cover 18 or beneath the mouth 30. Further, it is understood that the dispenser 10 could be mounted flush against a wall or fitted within a recessed cabinet. It is also a feature of the invention that interchangeable covers could be used to provide a consumer choices in the appearance of the dispenser. Moreover, in some cases, dispensers are used to dispense different kinds of sheet material and the color of the cover could be used to differentiate between dispensers. It will also be appreciate that the shape of the cover and rear housing illustrated and described herein is representative of only one embodiment and that other shapes and contours are contemplated and considered within the scope of the invention. Additionally, it is contemplated that the dispenser can be provided to a consumer with two lever options: lever 26 described above or a different lever design, such as a wrap around lever that places the activation lever generally below the mouth of the dispenser. Because the lever is designed to snap fit into the receiver of the drive lever, this interchangeability allows a purchaser variability in setting up the dispenser. Moreover, the drive lever can be disengaged from the receiver during shipping. This allows for smaller, more efficient packaging and also allows for larger driver levers.

From the foregoing description, it can be seen that the dispenser 10 provided by the invention is simply constructed. It has a minimum number of parts, especially moving parts. It can be made from inexpensive, but durable materials such as plastic by injection, blow, or roto molding or other conventional methods. It allows for easy replacement of the roll. It is aesthetically appealing. It can dispense lower tensile strength sheet material without tearing. It can dispense sheet material with or without a core equally well without modification or installation of additional parts. It will also be appreciated that the lever described herein could be used with other types of dispensers, including but not limited to other types of sheet material dispensers, condiment dispensers, soap or detergent dispensers, and the like. Additionally, the construction of the crank or handle encourages an operator to contact the crank using the non-palm side of the hand.

The dispenser of the present invention may have other applications aside from use in paper towel rolls and paper toweling. Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

We claim:

1. A sheet material dispenser comprising:
an enclosure comprising a front cover and a rear housing;
a feed mechanism for unwinding material from a roll of material maintained in the interior of said enclosure; and
a lever extending from the enclosure and interfacing with the feed mechanism such that movement of the lever causes the feed mechanism to advance material from the roll of material, wherein the lever includes a lever body adapted to be engaged with a non-face portion of a user's hand.

2. The dispenser of claim 1 wherein the lever body has a curved body defined between a down turned portion and an upturned portion.

3. The dispenser of claim 2 wherein the curved body provides a depression adapted to receive the edge of the user's hand or wrist.

4. The dispenser of claim 3 wherein the depression has a forward portion and a rearward portion, and wherein the rearward portion is elevated relative to the forward portion to provide an inclined depression.

5. The dispenser of claim 4 wherein the depression is angled relative to the rear housing.

6. The dispenser of claim 1 wherein the front cover attaches to the rear housing without using any tools.

7. The dispenser of claim 1 wherein the rear housing includes a back wall having a ramp structure for biasing the roll of sheet material with the feed mechanism.

8. An apparatus comprising:
a dispenser defining an interior compartment configured to support a roll of web material, the dispenser having a rear housing and a front cover engaged with the rear housing and cooperating with the rear housing to form an opening at lower ends of the front cover and the rear housing through which web material may be dispensed from the dispenser; and
a crank extending from a side of the dispenser and operably coupled to the dispenser such that movement of the crank causes web material to be advanced from the roll of web material out of the dispenser through the opening, wherein the crank is configured to be engaged by a crank contact area of a user's hand generally defined between the palm and the dorsal side of the user's hand.

9. The apparatus of claim 8 wherein the crank has a curved body defined between a down turned portion and an upturned portion.

10. The apparatus of claim 9 wherein the curved body provides a depression adapted to receive the crank contact area.

11. The apparatus of claim 10 wherein the depression has a forward portion and a rearward portion, and wherein the rearward portion is elevated relative to the forward portion to provide an inclined depression.

12. The apparatus of claim 11 wherein the depression is angled relative to the rear housing.

13. The apparatus of claim 8 wherein the front cover attaches to the rear housing without using any tools.

14. The apparatus of claim 8 wherein the dispenser includes a feed mechanism interconnected between the crank and the roll of web material and configured to advance web material from the roll of web material in response to movements of the crank, and wherein the rear housing includes a back wall having a ramp structure for biasing the roll of sheet material into engagement the feed mechanism.

15. A crank for use with a web material dispenser, comprising:
a first end adapted to engage a feed mechanism contained with the dispenser for advancing web material from a roll of web material housed within the web material dispenser, and a second end spaced from the first end by a crank body;
the crank body having a curvature that offsets the first end from the second end, and wherein the curvature forms a depression between the first end and the second end that is adapted to be engaged with an edge of a user's hand.

16. The crank of claim 15 wherein the depression is angled relative to a sidewall of the dispenser.

17. The crank of claim 15 wherein the crank body has a forward edge and a rearward edge, and wherein the depression is inclined from the forward edge to the rearward edge.
